(19) United States
(12) Patent Application Publication
(10) Pub. No.: US 2011/0084843 A1
(43) Pub. Date: Apr. 14, 2011

(54) MANAGEMENT SYSTEM AND MANAGEMENT SYSTEM FOR JUDGING CORRECTNESS OF SUBSTANCE IN A BOTTLE

(75) Inventors: CHIANG-LUAN LIU, TAIPEI COUNTY (TW); TZU-TO LIN, TAICHUNG CITY (TW); CHIEN HSIANG HUANG, TAIPEI COUNTY (TW); CHIN HUA CHUO, TAIPEI COUNTY (TW); HSIEN YEN LUNG, TAOYUAN COUNTY (TW); CHING HSIANG CHANG, MIAOLI COUNTY (TW)

(73) Assignee: INOTERA MEMORIES, INC., TAOYUAN COUNTY (TW)

(21) Appl. No.: 12/689,461

(22) Filed: Jan. 19, 2010

(30) Foreign Application Priority Data
Oct. 14, 2009 (TW) 98134774

(51) Int. Cl. G08B 21/00; G05D 7/06

(52) U.S. Cl. 340/603; 700/283

(57) ABSTRACT

A management system includes a container unit, a sensing unit, a control unit, a signal display unit and a liquid pumping unit. The container unit has a container, a liquid substance and an information storing element. The liquid substance has material information recorded in the information storing element. The sensing unit has an information reader for sensing the material information when the sensing unit joined with the container unit. The control unit electrically connects the information reader to receive the material information. The control unit has a material judging module for judging whether the material information is correct in order to generate a judgment result. The signal display unit has a signal display module for outputting a predetermined signal according to the judgment result. The liquid pumping unit has a liquid pumping module selectively inserted into the container to pump the liquid substance according to the judgment result.

### BACKGROUND OF THE INVENTION

1. Field of the Invention

The present invention relates to a management system and a management system, to a management system and a management system for judging correctness of substance in a bottle.

2. Description of Related Art

Material storage and dispensing vessels are used in a wide variety of industrial processes and commercial and personal applications. Various types of liquids and gases may be placed into vessels such as storage cylinders for transport and ultimately dispensation. One desirable industrial field for application of material storage and dispensing vessels is the fabrication of semiconductor devices.

In the fabrication of semiconductor devices, materials of various types and purposes are deposited on semiconductor substrates typically comprising monocrystalline material such as silicon dioxide. Deposited materials may include copper, aluminum, and other metals to form metal lines or other circuit features within trenches of the semiconductor substrate. Additional circuit features and material layers may be formed on the semiconductor substrate throughout the fabrication process.

In order to form trenches as described above, a photoresist material is first deposited above the semiconductor substrate. The manner of transport and delivery of photoresist material to the semiconductor substrate may be critical to the fabrication process. For example, the cost of applying a wrong type of photoresist may be quite extreme in terms of destroyed high-value semiconductor substrate, wasted high-purity chemicals, and manufacturing process interruption required to correct such an error. Despite this fact, photoresist material supply chains are usually managed with manual systems having intrinsic inefficiencies and a high risk for error, as the typical supply chain involves multiple parties each having independent material tracking platforms incapable of communicating with one another.

### SUMMARY OF THE INVENTION

In view of the aforementioned issues, the present invention provides a management system and a management system for judging correctness of substance in a bottle. The present invention can judge whether a substance in a bottle is correct or not before pumping the substance from the bottle by matching a container unit with an information storing element and a sensing unit with an information reader.

To achieve the above-mentioned objectives, the present invention provides a management system for judging correctness of substance in a bottle, including: a container unit, a sensing unit, a control unit, a signal display unit and a liquid pumping unit. The container unit has a container, a liquid substance stored in the container, and an information storing element joined with the container. The liquid substance has material information recorded in the information storing element. The sensing unit is selectively joined with or separated from the container unit, and the sensing unit has at least one information reader for sensing the material information when the sensing unit joined with the container unit. The control unit is electrically connected to the information reader of the sensing unit, in order to receive the material information that has been captured from the information storing element by the information reader. The control unit has a material judging module for judging whether the material information is correct or not in order to generate a judgment result. The signal display unit has at least one signal display module for outputting a predetermined signal according to the judgment result of the material judging module. The liquid pumping unit has at least one liquid pumping module selectively inserted into the container to pump the liquid substance according to the judgment result of the material judging module.

To achieve the above-mentioned objectives, the present invention provides a management method for judging correctness of substance in a bottle, including: providing a container unit that has a container, a liquid substance stored in the container, and an information storing element joined with the container, wherein the liquid substance has material information recorded in the information storing element; joining the container unit and a sensing unit with each other, wherein the sensing unit has at least one information reader; sensing the material information in the information storing element by the information reader of the sensing unit; using a control unit electrically connected to the information reader, in order to receive the material information that has been captured from the information storing element by the information reader; using a material judging module of the control unit to judge whether the material information is correct or not in order to generate a judgment result; using at least one signal display module of a signal display unit to output a predetermined signal according to the judgment result of the material judging module; and determining whether at least one liquid pumping module of a liquid pumping unit can be inserted into the container to pump the liquid substance according to the judgment result of the material judging module.

Therefore, the present invention not only can judge whether the liquid substance in the container is correct or not before pumping the liquid substance from the container by matching the information storing element and the information reader, but also can determine whether the liquid pumping module can be inserted into the container to pump the liquid substance according to the judgment result of the material judging module. Hence, the present invention can prevent the container from being inserted wrong and prevent the liquid substance from being pumped wrong.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are provided solely for reference and illustration, without any intention that they be used for limiting the present invention.

### BRIEF DESCRIPTION OF THE DRAWINGS

FIG. 1 is a functional block diagram of the management system according to the first embodiment of the present invention;

FIG. 2A is an exploded, schematic view of a first method for matching the container unit with the sensing unit according to the present invention;

FIG. 2B is an assembled, schematic view of a first method for matching the container unit with the sensing unit according to the present invention;

FIG. 3A is an exploded, schematic view of a second method for matching the container unit with the sensing unit according to the present invention;

FIG. 3B is an assembled, schematic view of a second method for matching the container unit with the sensing unit according to the present invention;

FIG. 4A is an exploded, schematic view of a third method for matching the container unit with the sensing unit according to the present invention;

FIG. 4B is an assembled, schematic view of a third method for matching the container unit with the sensing unit according to the present invention;

FIG. 5A is an exploded, schematic view of a fourth method for matching the container unit with the sensing unit according to the present invention;

FIG. 5B is an assembled, schematic view of a fourth method for matching the container unit with the sensing unit according to the present invention;

FIG. 6 is a functional block diagram of the management system according to the second embodiment of the present invention; and

FIG. 7 is a flowchart of the management method according to the present invention.

### DETAILED DESCRIPTION OF THE PREFERRED EMBODIMENTS

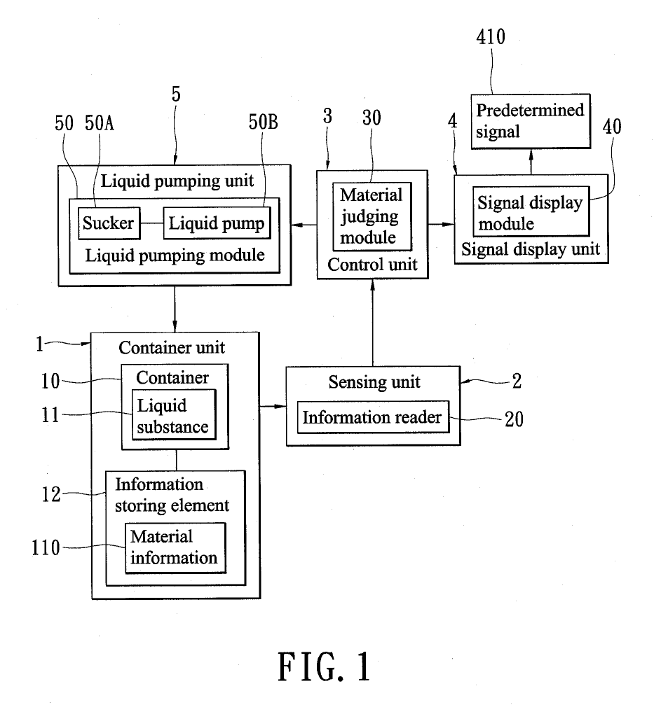

Referring to FIG. 1, the first embodiment of the present invention provides a management system for judging correctness of substance in a bottle, including: a container unit 1, a sensing unit 2, a control unit 3, a signal display unit 4 and a liquid pumping unit 5.

The container unit 1 has a container 10, a liquid substance 11 such as photoresist stored in the container 10, and an information storing element 12 joined with the container 10. The liquid substance 11 has material information 110 recorded in the information storing element 12. In addition, the information storing element 12 may be an RFID tag.

The sensing unit 2 is selectively joined with or separated from the container unit 1, and the sensing unit 2 has at least one information reader 20 for sensing the material information 110 when the sensing unit 2 joined with the container unit 1. In addition, the information reader may be an RFID reader.

The control unit 3 is electrically connected to the information reader 20 of the sensing unit 2, in order to receive the material information 110 that has been captured from the information storing element 12 by the information reader 20. The control unit 3 has a material judging module 30 for judging whether the material information 110 is correct or not in order to generate a judgment result.

The signal display unit 4 has at least one signal display module 40 for outputting a predetermined signal 410 according to the judgment result of the material judging module 30. For example, different signal display modules 40 can respectively generate different predetermined signals 410, as follows:

1. In the first aspect: the signal display module 40 may be a light-emitting element such as LED, so that the predetermined signal 410 generated by the light-emitting element is a light signal.

2. In the second aspect: the signal display module 40 may be an alarm, so that the predetermined signal 410 generated by the alarm is a voice signal.

3. In the third aspect: the signal display module 40 may be composed of a light-emitting element and an alarm, so that the predetermined signal 410 is generated by the light-emitting element and the alarm to form a light signal and a voice signal, respectively.

The liquid pumping unit 5 has at least one liquid pumping module 50 selectively inserted into the container 10 to pump the liquid substance 11 according to the judgment result of the material judging module 30. In addition, the liquid pumping module 50 has a sucker 50A selectively inserted into the container 10 according to the judgment result of the material judging module 30 and a liquid pump 50B connected with the sucker 50A and selectively started according to the judgment result of the material judging module 30. In other words, when the material judging module 30 judges the material information 110 is correct, the sucker 50A is allowable to be inserted into the container 10 and the liquid pump 50B is allowable to be started to pump the liquid substance 11. When the material judging module 30 judges the material information 110 is incorrect, the sucker 50A does not be inserted into the container 10 and the liquid pump 50B does not be turned on.

Moreover, the methods for matching the container unit 1 and the sensing unit 2 are shown as the following examples:

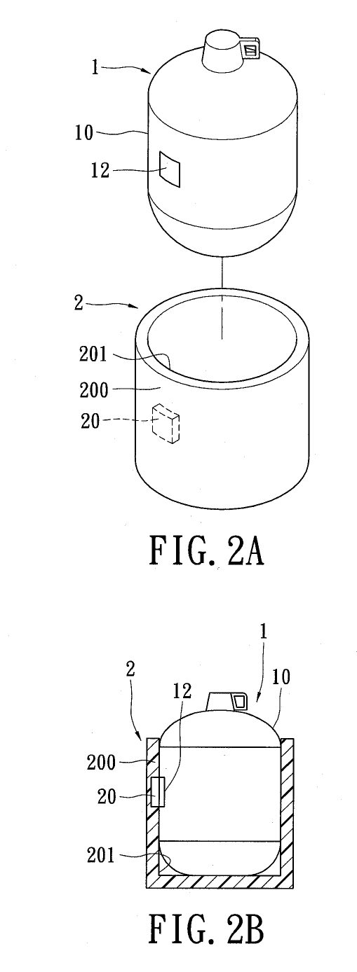

1. In the first example: referring to FIGS. 2A and 2B, the information storing element 12 is attached to an outer surface of the container 10, the sensing unit 2 has a receiving element 200 for selectively receiving the container 10, and the information reader 20 is positioned on the lateral surface 201 of the receiving element 200. When the container 10 is received in the receiving element 200 as shown in FIG. 2B, the information reader 20 faces the information storing element 12.

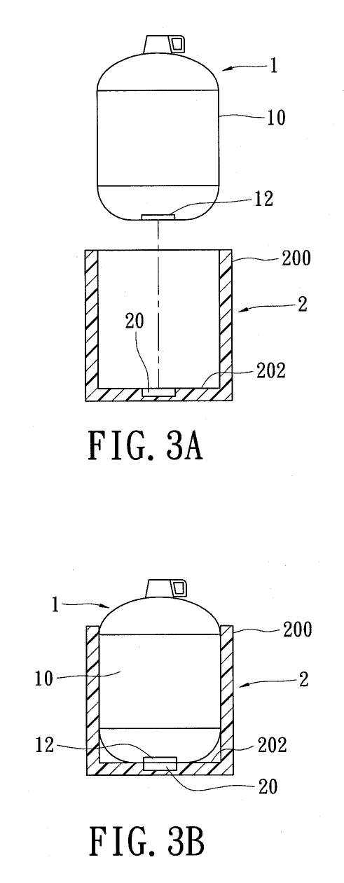

2. In the second example: referring to FIGS. 3A and 3B, the information storing element 12 is attached to an outer surface of the container 10, the sensing unit 2 has a receiving element 200 for selectively receiving the container 10, and the information reader 20 is positioned on the bottom surface 202 of the receiving element 200. When the container 10 is received in the receiving element 200 as shown in FIG. 3B, the information reader 20 faces the information storing element 12.

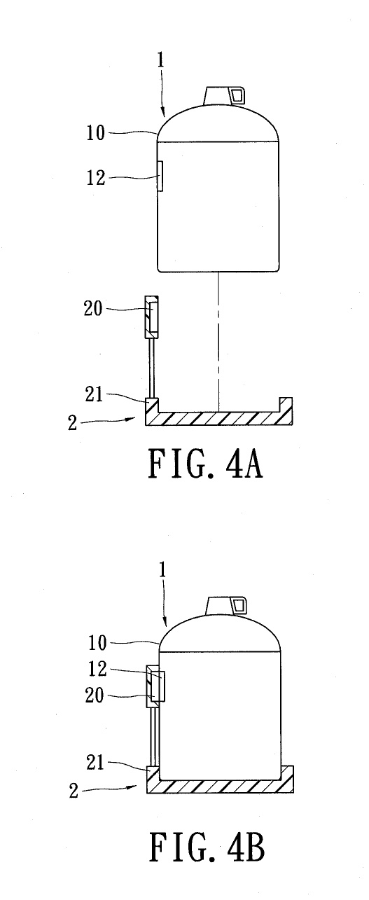

3. In the third example: referring to FIGS. 4A and 4B, the information storing element 12 is attached to an outer surface of the container 10, the sensing unit 2 has a positioning element 21 for selectively positioning the container 10, and the information reader 20 is positioned on the positioning element 21 and faces the information storing element 12. When the container 10 is positioned on the positioning element 21 as shown in FIG. 4B, the information reader 20 faces the information storing element 12.

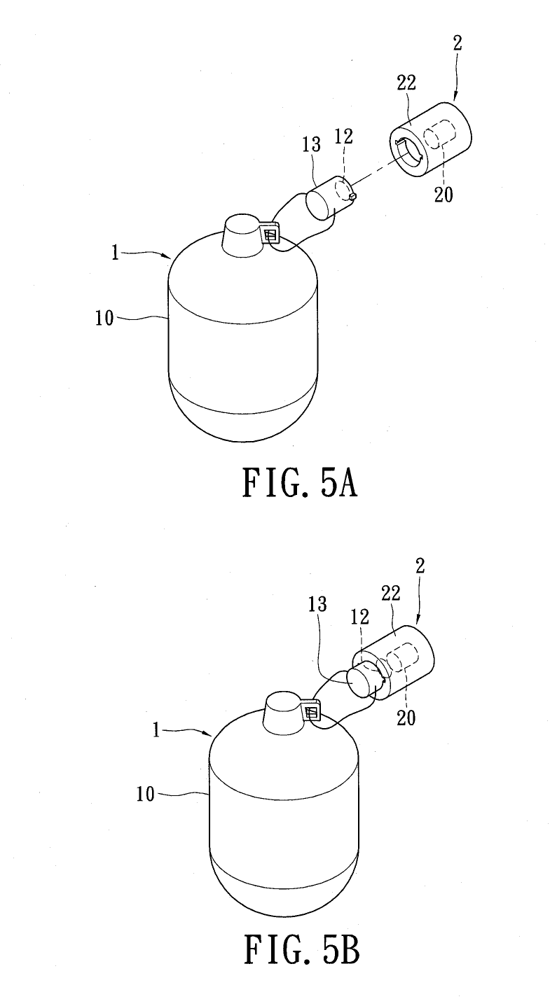

4. In the fourth example: referring to FIGS. 5A and 5B, the container unit 1 has a first retaining structure 13 joined with the container 10 (for example using a wire to join the first retaining structure 13 with the container 10), and the information storing element 12 is disposed on the first retaining structure 13. The sensing unit 2 has a second retaining structure 22 selectively mated with the first retaining structure 13, and the information reader 20 is positioned in the second retaining structure 22 and faces the information storing element 12. When the first retaining structure 13 is mated with the second retaining structure 22 as shown in FIG. 5B, the information reader 20 faces the information storing element 12.

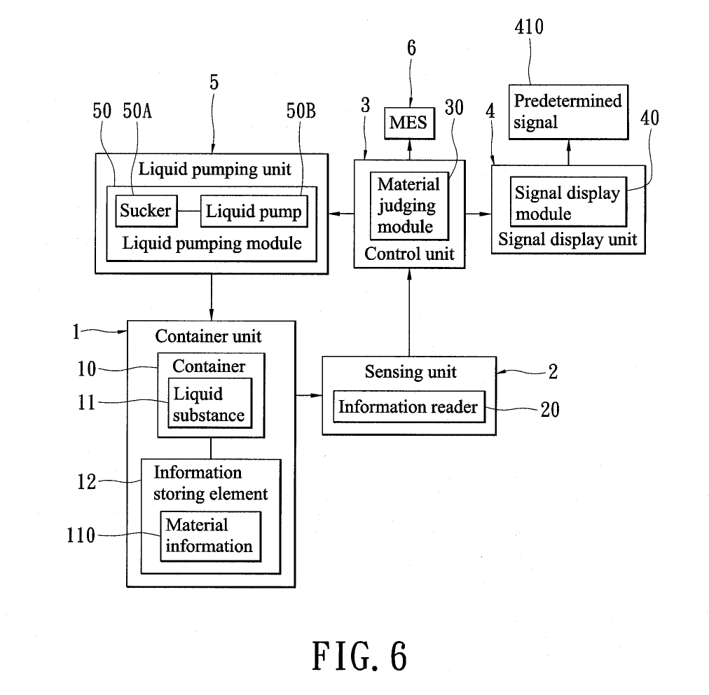

Referring to FIG. 6, the second embodiment of the present invention provides a management system for judging correctness of substance in a bottle, including: a container unit 1, a sensing unit 2, a control unit 3, a signal display unit 4 and a liquid pumping unit 5. The difference between the second embodiment and the first embodiment is that: the second embodiment further includes a manufacturing execution system (MES) 6 electrically connected to the control unit 3.

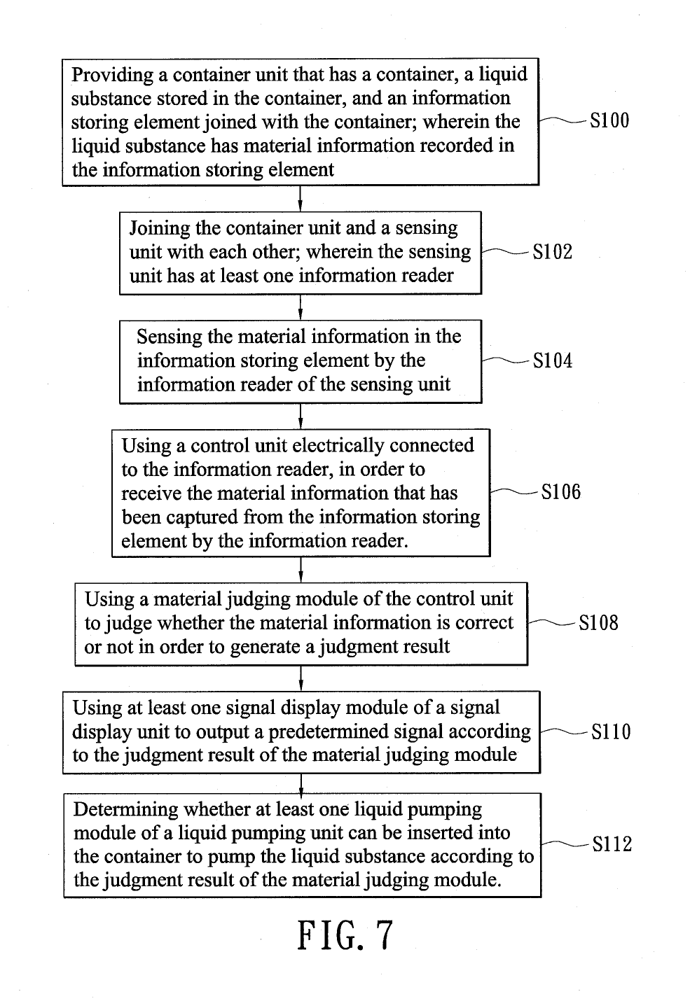

Referring to FIGS. 1 and 7, the present invention provides a management method for judging correctness of substance in a bottle, including the following steps:

The step S100 is that: providing a container unit 1 that has a container 10, a liquid substance 11 stored in the container 10, and an information storing element 12 joined with the container 10; wherein the liquid substance 11 has material information 110 recorded in the information storing element 12.

The step S102 is that: joining the container unit 1 and a sensing unit 2 with each other; wherein the sensing unit 2 has at least one information reader 20.

The step S104 is that: sensing the material information 110 in the information storing element 12 by the information reader 20 of the sensing unit 2.

The step S106 is that: using a control unit 3 electrically connected to the information reader 20, in order to receive the material information 110 that has been captured from the information storing element 12 by the information reader 20.

The step S108 is that: using a material judging module 30 of the control unit 3 to judge whether the material information 110 is correct or not in order to generate a judgment result.

The step S110 is that: using at least one signal display module 40 of a signal display unit 4 to output a predetermined signal 410 according to the judgment result of the material judging module 30. In other words, when the material judging module 30 judges the material information 110 is correct, the predetermined signal 410 outputted from the signal display module 40 is a normal signal. When the material judging module 30 judges the material information 110 is incorrect, the predetermined signal 410 outputted from the signal display module 40 is an abnormal signal.

The step S112 is that: determining whether at least one liquid pumping module 50 of a liquid pumping unit 5 can be inserted into the container 10 to pump the liquid substance 11 according to the judgment result of the material judging module 30. In other words, when the material judging module 30 judges the material information 110 is correct, the liquid pumping module 50 is inserted into the container 10 to pump the liquid substance 11. When the material judging module 30 judges the material information 110 is incorrect, the liquid pumping module 50 does not be inserted into the container 10.

In conclusion, the present invention not only can judge whether the liquid substance in the container is correct or not before pumping the liquid substance from the container by matching the information storing element and the information reader, but also can determine whether the liquid pumping module can be inserted into the container to pump the liquid substance according to the judgment result of the material judging module. Hence, the present invention can prevent the container from being inserted wrong and prevent the liquid substance from being pumped wrong. In other words, the liquid pumping module 50 can be inserted into the correct container 10 to pump the correct liquid substance 11 by using the management system and the management system of the present invention.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. A management system for judging correctness of substance in a bottle, comprising:
a container unit having a container, a liquid substance stored in the container, and an information storing element joined with the container, wherein the liquid substance has material information recorded in the information storing element;
a sensing unit selectively joined with or separated from the container unit, wherein the sensing unit has at least one information reader for sensing the material information when the sensing unit joined with the container unit;
a control unit electrically connected to the information reader of the sensing unit, in order to receive the material information that has been captured from the information storing element by the information reader, wherein the control unit has a material judging module for judging whether the material information is correct or not in order to generate a judgment result;
a signal display unit having at least one signal display module for outputting a predetermined signal according to the judgment result of the material judging module; and
a liquid pumping unit having at least one liquid pumping module selectively inserted into the container to pump the liquid substance according to the judgment result of the material judging module.

2. The management system according to claim 1, wherein the information storing element is an RFID tag, and the information reader is an RFID reader.

3. The management system according to claim 1, wherein the information storing element is attached to an outer surface of the container, the sensing unit has a receiving element for selectively receiving the container, and the information reader is positioned in the receiving element and faces the information storing element.

4. The management system according to claim 1, wherein the information storing element is attached to an outer surface of the container, the sensing unit has a positioning element for selectively positioning the container, and the information reader is positioned on the positioning element and faces the information storing element.

5. The management system according to claim 1, wherein the container unit has a first retaining structure joined with the container, the information storing element is disposed on the first retaining structure, the sensing unit has a second retaining structure selectively mated with the first retaining structure, and the information reader is positioned in the second retaining structure and faces the information storing element.

6. The management system according to claim 1, wherein the signal display module is a light-emitting element, so that the predetermined signal generated by the light-emitting element is a light signal.

7. The management system according to claim 1, wherein the signal display module is an alarm, so that the predetermined signal generated by the alarm is a voice signal.

8. The management system according to claim 1, wherein the signal display module is composed of a light-emitting element and an alarm, so that the predetermined signal is generated by the light-emitting element and the alarm to form a light signal and a voice signal, respectively.

9. The management system according to claim 1, wherein the liquid pumping module has a sucker selectively inserted into the container according to the judgment result of the material judging module and a liquid pump connected with the sucker and selectively started according to the judgment result of the material judging module.

10. The management system according to claim 1, further comprising: a manufacturing execution system electrically connected to the control unit.

11. A management method for judging correctness of substance in a bottle, comprising:
providing a container unit that has a container, a liquid substance stored in the container, and an information storing element joined with the container, wherein the liquid substance has material information recorded in the information storing element;
joining the container unit and a sensing unit with each other, wherein the sensing unit has at least one information reader;
sensing the material information in the information storing element by the information reader of the sensing unit;
using a control unit electrically connected to the information reader, in order to receive the material information that has been captured from the information storing element by the information reader;
using a material judging module of the control unit to judge whether the material information is correct or not in order to generate a judgment result;
using at least one signal display module of a signal display unit to output a predetermined signal according to the judgment result of the material judging module; and
determining whether at least one liquid pumping module of a liquid pumping unit can be inserted into the container to pump the liquid substance according to the judgment result of the material judging module.

12. The management method according to claim 11, wherein when the material judging module judges the material information is correct, the predetermined signal outputted from the signal display module is a normal signal; when the material judging module judges the material information is incorrect, the predetermined signal outputted from the signal display module is an abnormal signal.

13. The management method according to claim 11, wherein when the material judging module judges the material information is correct, the liquid pumping module is inserted into the container to pump the liquid substance; when the material judging module judges the material information is incorrect, the liquid pumping module does not be inserted into the container.

14. The management method according to claim 11, wherein the information storing element is attached to an outer surface of the container, the sensing unit has a receiving element for selectively receiving the container, and the information reader is positioned in the receiving element and faces the information storing element.

15. The management method according to claim 11, wherein the information storing element is attached to an outer surface of the container, the sensing unit has a positioning element for selectively positioning the container, and the information reader is positioned on the receiving element and faces the information storing element.

16. The management method according to claim 11, wherein the container unit has a first retaining structure joined with the container, the information storing element is disposed on the first retaining structure, the sensing unit has a second retaining structure selectively mated with the first retaining structure, and the information reader is positioned in the second retaining structure and faces the information storing element.

17. The management method according to claim 11, wherein the signal display module is a light-emitting element, so that the predetermined signal generated by the light-emitting element is a light signal.

18. The management method according to claim 11, wherein the signal display module is an alarm, so that the predetermined signal generated by the alarm is a voice signal.

19. The management method according to claim 11, wherein the signal display module is composed of a light-emitting element and an alarm, so that the predetermined signal is generated by the light-emitting element and the alarm to form a light signal and a voice signal, respectively.

20. The management method according to claim 11, wherein the liquid pumping module has a sucker selectively inserted into the container according to the judgment result of the material judging module and a liquid pump connected with the sucker and selectively started according to the judgment result of the material judging module.
